(19) United States
(12) Patent Application Publication
(10) Pub. No.: US 2020/0387430 A1
(43) Pub. Date: Dec. 10, 2020

(54) STORAGE APPARATUS AND BACKUP METHOD FOR SETTING PECULIAR EVENT AS RESTORE POINT

(71) Applicant: Hitachi, Ltd., Tokyo (JP)

(72) Inventors: Kazuei HIRONAKA, Tokyo (JP); Takaki MATSUSHITA, Tokyo (JP); Tomohiro KAWAGUCHI, Tokyo (JP)

(73) Assignee: Hitachi, Ltd.

(21) Appl. No.: 16/796,869

(22) Filed: Feb. 20, 2020

(30) Foreign Application Priority Data
Jun. 10, 2019 (JP) 2019-107929

(51) Int. Cl. G06F 11/14; G06F 11/30; G06F 3/06

(52) U.S. Cl. CPC G06F 11/1464; G06F 11/1469; G06F 11/1461; G06F 11/1451; G06F 2201/84; G06F 3/0619; G06F 3/0653; G06F 3/0658; G06F 3/067; G06F 11/3034

(57) ABSTRACT

A storage apparatus including a controller; a first volume provided to a host; and a second volume for storage of backup data or a snapshot image of the first volume. The controller periodically acquires the backup data or the snapshot image of the first volume at predetermined intervals; acquires monitoring information including access information of the host and a volume used capacity in the first volume and sets a normal state of the first volume in typical use using the acquired monitoring information; detects an access behavior in a volume deviating from the set normal state; and creates the backup data or the snapshot of the first volume in the second volume at a point in time of detection and sets a restore point to perform management.

### BACKGROUND OF THE INVENTION

### 1. Field of the Invention

The present invention generally relates to data processing performed by a storage system.

### 2. Description of the Related Art

From the viewpoint of business continuity plans (BCPs) in IT systems, it is required for a storage apparatus to securely store a backup of data stored in the storage apparatus and to spread the data quickly when necessary.

Japanese Patent No. 5657801 discloses a storage system that provides a volume snapshot function.

Japanese Patent No. 5657801 discloses a volume snapshot technique in which a first logical volume provided in a host and a secondary volume for holding one or more snapshot images associated with the first logical volume are configured, time relation information indicating a time relationship at a snapshot acquisition point of time to the first volume is stored, and whether a data element is a data element constituting the snapshot image based on the time relation information for a logical area in which the data element that needs to be written by the host needs to be stored when the host writes the data in the first volume, thereby acquiring the snapshot image of the first volume.

### SUMMARY OF THE INVENTION

Enterprises have taken action for the business continuity plans (BCPs) in the IT systems in order to continue and recover business in the event of an emergency such as a natural disaster and a cyber attack. Therefore, the storage system that can store important data also needs to support these BCPs. In recent years, the number of cyber attacks of the destruction of service (DeOS) type, including ransomware, has been increasing rapidly.

These attacks not only cause the IT systems in operation to stop the service, but also destroy the data and backups of the IT systems, which results in serious damage to the IT systems and the business itself. In order to protect data from such damage, the storage apparatus provides a data backup function using a copy function in a storage housing, a remote replication function to another storage apparatus installed in a remote place, and the like.

In actual destruction-of-service attacks, however, it takes time until damage becomes apparent after an IT system is attacked and measures are actually taken. Therefore, in an operation method of backups regularly acquired by schedule management as in the conventional backup, there is a possibility that backup data may have a low value as a considerable amount of time has passed since the latest state even if the acquired backup data is backup data after being destroyed by the cyber attack or is backup data before the cyber attack.

In addition, when considering a recovery procedure of backed up data, information for identification of backup data that needs to be restored is severely damaged by the cyber attack, and there is no choice but to identify a data restore point based on the time at which an incident was discovered. For this reason, in the cyber attack accompanied by data destruction, it is difficult to identify the restore point before the data destruction.

Therefore, an object of the present invention is to provide a storage apparatus and a backup method having a data backup technique capable of minimizing damage of a cyber attack accompanied by data destruction described above and facilitating a restore operation.

In particular, another object is to provide a storage apparatus and a backup method for monitoring occurrence of an event deviating from a behavior during a typical operation based on various types of monitoring information in a storage system (for example, I/O information with respect to a backup target volume, a change in data compression rate, a change in data capacity), and the like and automatically performing setting of a data backup and setting of a restore point using the event as a trigger.

An aspect of a storage apparatus according to the present invention that solves the above-described problems is a storage apparatus including a controller; a first volume provided to a host; and a second volume for storage of backup data or a snapshot image of the first volume. The controller periodically acquires the backup data or the snapshot image of the first volume at predetermined intervals; acquires monitoring information including access information of the host and a volume used capacity in the first volume and sets a normal state of the first volume in typical use using the acquired monitoring information; detects an access behavior in a volume deviating from the set normal state; and creates the backup data or the snapshot of the first volume in the second volume at a point in time of detection and sets a restore point to perform management.

According to the representative embodiment of the present invention, a backup or a snapshot image is acquired based on time information set in advance in the first volume, and further, backup data and a snapshot image are created autonomously based on the monitoring information. For this reason, even if a cyber attack with ransomware that aims at data destruction causes data destruction in the first volume, a storage administrator can find the cyber attack at an early stage based on a notification from the storage apparatus, and can minimize damage caused by the cyber attack.

Other objects, configurations, and effects which have not been described above become apparent from an embodiment to be described hereinafter.

### BRIEF DESCRIPTION OF THE DRAWINGS

FIG. 1 is a diagram illustrating a storage apparatus;

FIG. 2 is a diagram illustrating a backup in an apparatus;

FIG. 3 is a diagram illustrating a remote replication;

FIG. 4 is a view illustrating management information;

FIG. 5 is a view illustrating an LDEV management table;

FIG. 6 is a view illustrating a pool management table;

FIG. 7 is a view illustrating a pool VOL table;

FIG. 8 is a view illustrating an LDEV monitoring information table;

FIG. 9 is a view illustrating an LDEV data protection policy management table;

FIG. 10 is a view illustrating an LDEV automatic data protection policy management table;

FIG. 11 is a view illustrating an LDEV backup management table;

FIG. 12 is a view illustrating a learning flow of LDEV access information according to an abnormality determination program; and

FIG. 13 is a view illustrating an LDEV access abnormality detection flow according to the LDEV monitoring program.

### DESCRIPTION OF THE PREFERRED EMBODIMENTS

An embodiment of the present invention will be described with reference to the drawings.

Incidentally, the embodiment to be described hereinafter does not limit the invention according to the claims, and further, all combinations of elements described in the embodiment are not necessarily indispensable for the solution of the invention. In the following description, various types of information will be described using expressions, such as “xxx table”, “xxx list”, “xxx DB”, and “xxx queue”, but the various types of information may also be expressed in data structures other than the table, the list, the DB, and the queue. Therefore, “xxx table”, “xxx list”, “xxx DB”, and “xxx queue” will also be referred to as “xxx information” in order to illustrate that there is no dependency on the data structure.

Further, when describing the contents of each piece of the information, expressions, such as “identification information”, “identifier”, “name”, and “ID”, will be used, but these expressions are interchangeable.

Further, the embodiment of the present invention to be described below may be implemented by software running on a general-purpose computer, or may be implemented by dedicated hardware or a combination of software and hardware.

Further, there is a case where processing is described with “program” as a subject in the following description, but the description may be given using a processor as the subject since the program is executed by the processor (for example, a central processing unit (CPU)) to perform the prescribed processing using a storage resource (for example, a memory) and a communication I/F, and a port.

The processing described with the program as the subject may be processing performed by a computer having the processor (for example, a calculation host or a storage apparatus). In the following description, the expression “controller” may refer to a processor or a hardware circuit that performs part or whole of the processing performed by the processor. The program may be installed in each computer from a program source (for example, a program distribution server or a computer-readable storage medium). In this case, the program distribution server includes a CPU and a storage resource, and the storage resource further stores a distribution program and a distribution target program. When the CPU executes the distribution program, the CPU of the program distribution server distributes the distribution target program to another computer.

In the following description, “PDEV” means a physical storage device, and may typically be a nonvolatile storage device (for example, an auxiliary storage device). The PDEV may be, for example, a hard disk drive (HDD) or a solid state drive (SSD). Different types of PDEVs may coexist in the storage system.

In the following description, “RAID” is an abbreviation for redundant array of inexpensive disks. A RAID group includes a plurality of PDEVs (typically the same type of PDEVs) and stores data according to a RAID level associated with the RAID group. The RAID group may be referred to as a parity group. The parity group may be, for example, an RAID group that stores a parity.

In the following description, “VOL” is an abbreviation for a volume, and may be a physical storage device or a logical storage device. The VOL may be a real VOL (RVOL) or a virtual VOL (VVOL). “RVOL” may be a VOL based on a physical storage resource (for example, one or more RAID groups) provided in a storage system that includes the RVOL. “VVOL” may be any one of an externally coupled VOL (EVOL), a thin provisioning VOL (TPVOL), and a snapshot VOL. The EVOL is based on a storage space of an external storage system (for example, VOL), and may be a VOL in conformity with a storage virtualization technique. The “TPVOL” may be a VOL that is constituted by a plurality of virtual areas (virtual storage areas) and conforms to a capacity virtualization technique (typically, thin provisioning).

In the following description, the snapshot may be a VOL provided as a snapshot of the original VOL or a logical storage device.

In addition, as a realization scheme, the snapshot may be realized as a snapshot in a scheme of collectively recording data update differential performed on the VOL from a certain time to a certain time, or may be realized with continuous data protection (CDP) that records all data updates performed on the VOL in a time-series manner.

“Pool” is a logical storage area (for example, a set of a plurality of pool VOLs), and may be prepared for each application. For example, the pool may be at least one of a TP pool and a snapshot pool. The TP pool may be a storage area constituted by a plurality of pages (substantial storage areas). When a page is not allocated to a virtual area (virtual area of TPVOL) to which an address specified by a write request received from a host system (hereinafter, a host) belongs, the storage controller allocates a page from the TP pool to the virtual area (write destination virtual area) (a page may be newly allocated to the write destination virtual area even if a page has been allocated to the write destination virtual area).

The storage controller may write target data accompanying the write request to the allocated page. The snapshot pool may be a storage area storing data saved from the original VOL. One pool may be used as both the TP pool and the snapshot pool. “Pool VOL” may be a VOL that is a component of the pool. The pool VOL may be a RVOL or an EVOL.

In the following description, the VOL recognized by the host (VOL provided to the host) is referred to as “LDEV”. In the following description, the LDEV is the TPVOL (or RVOL), and the pool is the TP pool. However, the invention can also be applied to storage apparatuses that do not employ the thin provisioning.

In the following description, “PVOL (Primary VOL)” may be an LDEV that is a source volume for the backup, the replication, and the snapshot, and “SVOL (Secondary VOL)” may be an LDEV that is a destination for the backup, the replication, or the snapshot.

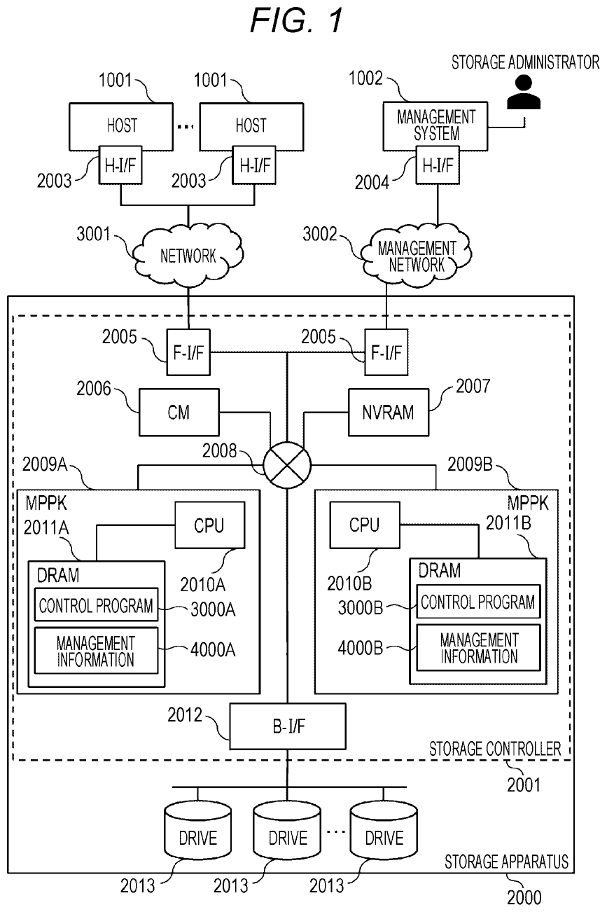

FIG. 1 illustrates a configuration example of a storage apparatus according to a first embodiment.

One or more hosts 1001 are connected to a storage apparatus 2000 via a network 3001. A management system 1002 is connected to the storage apparatus 2000. The network 3001 is, for example, a fiber channel (FC) or an internet small computer system interface (iSCSI).

The host 1001 is an abbreviation of the host system, and one or more hosts are present. The host 1001 includes a host interface device (H-I/F) 2003, and transmits an access request (a write request or a read request) to the storage apparatus 2000 via the H-I/F 2003, or receives a response to the access request (for example, a write response including write completion or a read response including a read target chunk). The H-I/F 2003 is, for example, a host bus adapter (HBA) or a network interface card (NIC).

The management system 1002 manages a configuration and a state of the storage apparatus 2000. The management system 1002 includes a management interface device (M-I/F) 2004, and transmits a command to the storage apparatus 2000 or receives a response to the command via the M-I/F. The M-I/F 2004 is, for example, a NIC.

In addition, the management system 1002 may be software executed on a server or a PC that manages the storage apparatus 2000, and may be implemented as a function of a security appliance or software that manages the host 1001 connected to the storage apparatus 2000.

The storage apparatus 2000 includes a plurality of drives 2013 and a storage controller 2001 connected to the plurality of drives 2013. One or more RAID groups including the plurality of drives 2013 may be configured.

The storage controller 2001 includes a front-end interface device (F-I/F) 2005, a back-end interface device (B-I/F) 2012, a cache memory (CM) 2006, a non-volatile RAM (NVRAM) 2007, an MPPK 2009A and an MPPK 2009B, and a relay 2008 that relays communication between these elements. The relay is, for example, a bus or a switch.

The F-I/F 2005 is an I/F that communicates with the host 1001 or a management server. The B-I/F 2012 is an I/F that communicates with the drive 2013. The B-I/F 2012 may include an E/D circuit (a hardware circuit for encryption and decryption). Specifically, for example, the B-I/F 2012 may include a serial attached SCSI (SAS) controller, and the SAS controller may include the E/D circuit.

In the CM 2006 (for example, a dynamic random access memory (DRAM)), data written to the drive 2013 or data read from the drive 2013 is temporarily stored by the MPPK 2009. The data (for example, dirty data (data which has not been written in the drive 2013)) in the CM 2006 is saved in the NVRAM 2007 by the MPPK 2009 supplied with power from a battery (not illustrated) at the time of power interruption.

A cluster is configured by the MPPK 2009A and the MPPK 2009B. The MPPK 2009A (MPPK 2009B) has a DRAM 2011A (2011B) and a CPU 2010A (CPU 2010B). The DRAM 2011A (DRAM 2011B) stores a control program 3000A (control program 3000B) executed by the CPU 2010A (CPU 2010B), and management information 4000A (management information 4000B) referred to or updated by the CPU 2010A (CPU 2010B). The CPU 2010A (CPU 2010B) executes the control program 3000A (control program 3000B), thereby executing, for example, I/O processing and address conversion processing of the storage apparatus 2000. At least one of the control program 3000A (control program 3000B) and the management information 4000A (management information 4000B) may be stored in a storage area (for example, the CM 2006) shared by the plurality of MPPK 2009A and MPPK 2009B.

### <LDEV Data Protection Method>

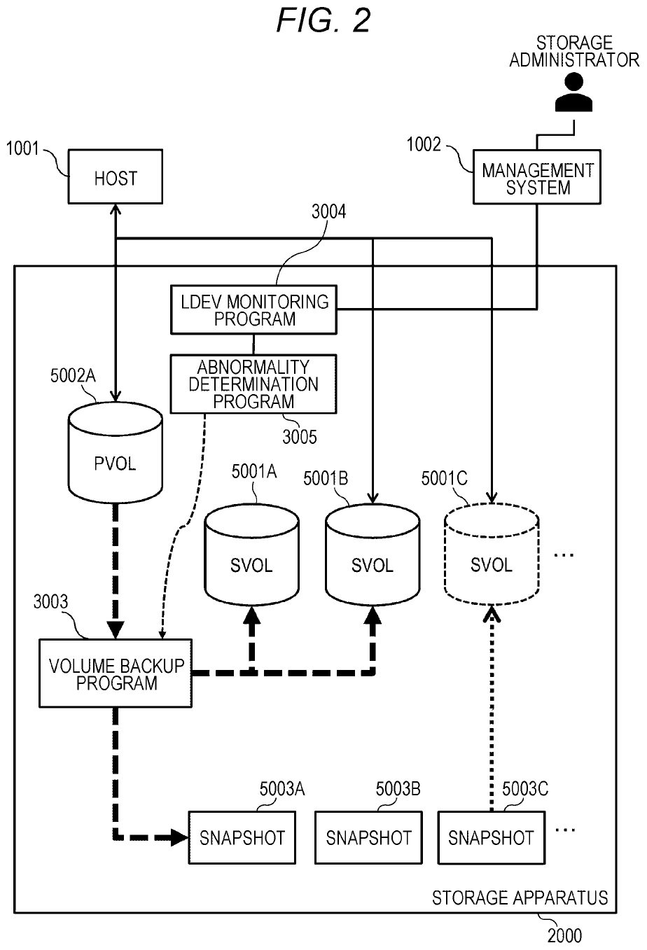

FIG. 2 illustrates a configuration example of a backup in the storage apparatus according to the first embodiment.

FIG. 2 illustrates an example in which a PVOL 5002A, which is a primary volume connected to the host 1001, is backed up in the storage apparatus 2000.

The PVOL 5002A uses a volume backup program 3003 to back up data to an SVOL 5001A and an SVOL 5001B, which are secondary volumes in which the data of PVOL 5002A has been replicated, or a snapshot 5003A, a snapshot 5003B, and a snapshot 5003C according to a data protection policy set in advance by an administrator of the storage apparatus. The volume backup program 3003, an LDEV monitoring program 3004, and an abnormality determination program 3005 are programs that constitute a part of the control program 3000. The volume backup program 3003, LDEV monitoring program 3004, and abnormality determination program 3005 are executed by the CPU 2010 of the storage controller 2001 to realize the respective functions of a volume backup unit, an LDEV monitoring unit, and an abnormality determination unit.

Specifically, the data protection policy is access control such as a schedule for creation of the SVOL 5001, which is created as a backup by replicating data of the PVOL 5002, a storage expiration date, and read/write permission.

At this time, the SVOL 5001B and SVOL 5001C replicating data may be created by completely replicating data from the PVOL 5002A, or may be created by replicating only differential data updated from the previous backup time.

The snapshot 5003A, the snapshot 5003B, and the snapshot 5003C are data sets that reproduce a data state of the PVOL 5002A at a certain point in time. When only a data differential updated from the time when the snapshot was previously created is recorded in the next time snapshot, it is possible to reduce the amount of data required for data storage. In addition, the snapshot can be appropriately mounted on the LDEV, and the host 1001 can access data of the snapshot as the snapshot 5003C is mounted on the PVOL 5001C.

The LDEV monitoring program 3004 is a program of monitoring access information with respect to the LDEV accessed by the host 1001 (for example, read and write I/O counts, a data compression rate, and the like) and LDEV information (for example, a LDEV consumption capacity, a data compression rate, and the like). The storage administrator can grasp a state of the LDEV from the management system 1002 as the management system 1002 accesses the LDEV monitoring program 3004.

### <LDEV Data Automatic Protection>

Here, an automatic data protection method based on LDEV access information will be described.

In recent years, the damage of cyber attacks that perform data destructive attacks such as ransomware has been increasing. When infected, the ransomware threatens enterprises and individuals by encrypting data stored in IT systems and requiring money instead of passing on a key to decrypt the data. For this reason, a method of protecting data from the ransomware can be also considered in storage apparatuses connected to the IT systems and storing the data.

In order to protect data from ransomware involving encryption, data restoration using a backup can be considered. However, in the cyber attack using the ransomware, there is a certain time lag between the time when the infection of ransomware first occurs and the time when damage becomes apparent and a countermeasure is taken, and thus, there is also a problem that it is difficult to determine which point in time data needs to be restored even when it is attempted to restore data from a backup.

Therefore, the technique disclosed in the present application mainly focuses on the ransomware that encrypts data, and automatically sets data backup and restore points based on LDEV access information accompanying the ransomware data encryption.

When data has been encrypted and destroyed by ransomware, it is possible to quickly restore the data to a state before being destroyed by the ransomware based on these automatically set data backup and restore points.

More specifically, the LDEV monitoring program 3004 monitors access information of each of the PVOLs 5002, and learns typical access information of the PVOL 5002 generated when the host 1001 accesses the PVOL 5002 using the abnormality determination program 3005. When the data destruction accompanied by data encryption occurs due to the ransomware, access information with respect to the PVOL 5002 is different from the learned typical operation. Thus, the abnormality determination program 3005 notifies the storage administrator of abnormality detection through the management system 1002, starts the volume backup program 3003, and creates the SVOL 5001 or the snapshot 5003 for the backup for each of the PVOLs 5002 by a method defined by the data protection policy.

In this manner, scheduled backup data, defined in advance in the data protection policy of the PVOL 5002, is created, and further, a point in time when the abnormality determination program 3005 detects that the access information with respect to the PVOL 5002 is different from the typical state can be set as a point in time of backup data creation. For this reason, it is possible to restore the data of the PVOL 5002 immediately after or immediately before the data destruction activity by the ransomware is started, and thus, it is possible to restore a large amount of data before the data destruction from the backup.

In addition, a specific implementation scheme of the abnormality determination program 3005 may employ a statistical method of using a fact that one or more types of values among various monitoring values obtained by the LDEV monitoring program 3004 exceed a predetermined threshold for a certain period as a trigger in addition to the learning of the access information or may employ a machine learning algorithm using a similar monitoring value. The implementation scheme may be configured to use learning with a deep learning algorithm.

Note that the abnormality determination program 3005 may be movable inside the storage apparatus 2000, or may be implemented to be movable in the management system 1002 or the host 1001.

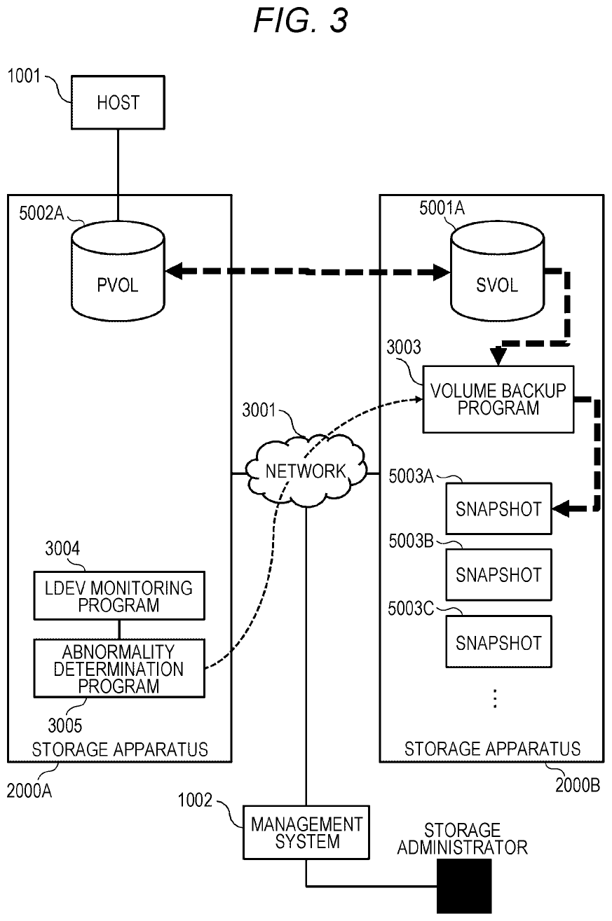

FIG. 3 illustrates an example of a data backup using a remote replication between storage apparatuses according to the first embodiment.

FIG. 3 illustrates the embodiment in which, for the purpose of BCP support and DR, data protection using a backup and a snapshot is performed while configuring a remote replication between the storage apparatuses 2000 installed in remote locations.

The embodiment of FIG. 3 illustrates a configuration in which a storage apparatus 2000A and a storage apparatus 2000B installed in different remote data centers or the like are connected via the network 3001, and the PVOL 5002A of the storage apparatus 2000A and the SVOL 5001A of the storage apparatus 2000B have a pair relationship.

The PVOL 5002A of the storage apparatus 2000A and the SVOL 5001A of the storage apparatus 2000B are synchronized with each other as the remote replication pair relationship. A synchronization scheme at this time may be a scheme in which synchronization is performed with data update to the PVOL 5002A, or a scheme in which differential data with respect to the PVOL 5002A is asynchronously reflected to the SVOL 5001A.

In the storage apparatus 2000B, the snapshot 5003 or a volume backup of the SVOL 5001A is periodically acquired by the volume backup program 3003 based on a preset data protection policy of the SVOL 5001A.

In the storage apparatus 2000A, the LDEV monitoring program 3004 monitors access information of the PVOL 5002A accessed from the host 1001, and the abnormality determination program learns access information obtained when the typical host 1001 accesses the PVOL 5002A. A specific implementation scheme of the abnormality determination program 3005 may employ a statistical method of using a fact that one or more types of values among various monitoring values obtained by the LDEV monitoring program 3004 exceed a predetermined threshold for a certain period as a trigger in addition to the learning of the access information or may employ a machine learning algorithm using a similar monitoring value. The implementation scheme may be configured to use learning with a deep learning algorithm.

When data of the PVOL 5002A has been destroyed by ransomware or the like, the abnormality determination program 3005 detects an access abnormality with respect to the PVOL 5002A, notifies the storage administrator of the abnormality detection through the management system 1002, and instructs the volume backup program 3003 of the storage apparatus 2000B to create backup data of the SVOL 5001A.

The volume backup program 3003 creates the snapshot 5003A of the SVOL 5001A so that the data of the PVOL 5002A is protected as backup data (snapshot 5003A) of the replication destination SVOL 5001A.

Here, the LDEV monitoring program 3004 may operate in the storage apparatus 2000B, or the abnormality determination program 3005 may operate in the storage apparatus 2000B or the management system 1002.

In the above-described manner, automatic data protection is realized based on the abnormality of access information in addition to the pre-scheduled backup based on data protection policy or the data backup using the snapshot, in the remote replication configuration constructed between the plurality of storage apparatuses 2000. Thus, data security is improved as compared with the case where only the remote replication of the PVOL 5002A is constructed.

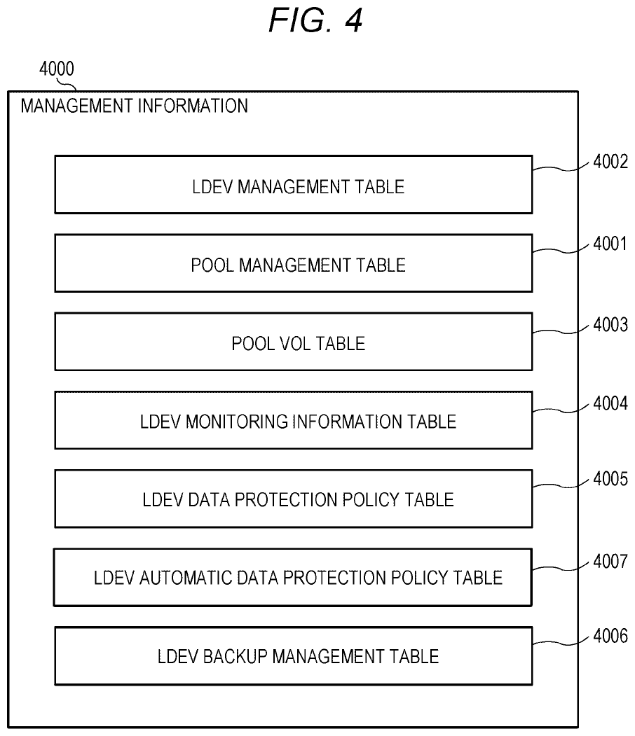

FIG. 4 illustrates a configuration example of management information in the storage apparatus of the embodiment.

Management information 4000 includes a plurality of management tables. The management tables are, for example, an LDEV management table 4002 holding information on the LDEV such as the PVOL 5002 and SVOL 5001, a pool management table 4001 holding information on a pool providing the logical capacity to the LDEV, a pool VOL table 4003 holding information on the pool VOL that provides the capacity to the pool, an LDEV monitoring information table 4004 managing the LDEV monitoring information, an LDEV data protection policy table 4005 managing the LDEV data protection policy, an LDEV automatic data protection policy table 4007 managing an LDEV data automatic protection policy, and an LDEV backup management table 4006 managing backup data of the PVOL 5002. At least part of the information may be synchronized between the management information 4000A and the management information 4000B.

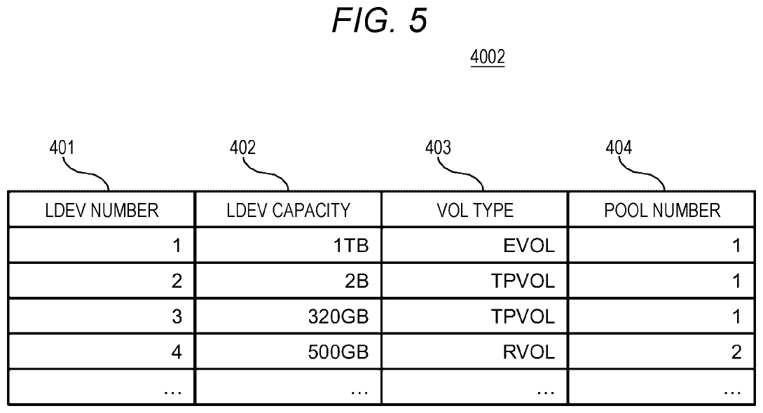

FIG. 5 illustrates a configuration example of the LDEV management table in the management information of the storage apparatus according to the embodiment.

The LDEV management table 4002 has an entry (record) for each LDEV such as the PVOL 5002 and SVOL 5001. The information stored in each entry is an LDEV number 401, an LDEV capacity 402, a VOL type 403, and a pool number 404.

The LDEV number 401 indicates an identification number of the LDEV. The LDEV capacity 402 indicates the capacity of the LDEV. The VOL type 403 indicates a type of the LDEV, and indicates, for example, an external volume “EVOL” provided from an external apparatus of the storage apparatus 2000, a remote volume “RVOL”, or a thin provisioning volume “TPVOL”. The pool number 404 indicates an identification number of the pool with which the LDEV is associated, and a data storage area is allocated from an area in the pool with which the pool number 404 is associated.

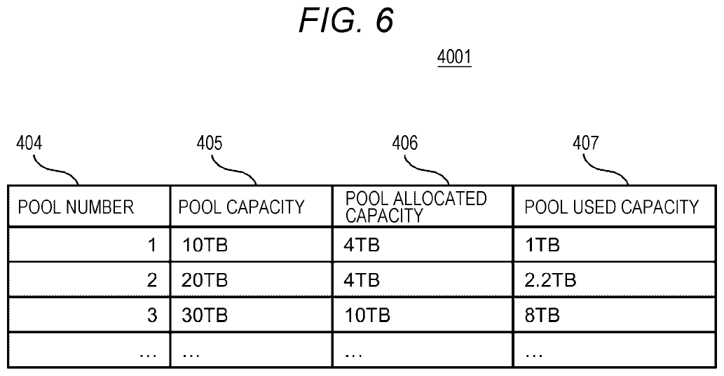

FIG. 6 illustrates a configuration example of the pool management table in the management information of the storage apparatus according to the embodiment.

The pool management table 4001 has an entry for each pool. Information stored in each entry is the pool number 404, a pool capacity 405, a pool allocated capacity 406, and a pool used capacity 407.

The pool number 404 indicates the identification number of the pool. The pool capacity 405 indicates a defined capacity of the pool, specifically, the sum of one or more VOL capacities corresponding to one or more pool VOLs constituting the pool. The pool allocated capacity 406 indicates an actual capacity allocated to one or more LDEVs, specifically, the capacity of the entire page group allocated to one or more LDEVs. The pool used capacity 407 indicates the total amount of data stored in the pool. When data reduction (at least one of compression and deduplication) is performed on data, the pool used capacity 407 may be calculated by the MPPK 2009 based on the amount of data after the data reduction. When the drive 2013 performs data compression, the MPPK 2009A may calculate the pool used capacity 407 based on the amount of data before the compression or may calculate the pool used capacity 407 based on the amount of data after the compression.

The notification of the data amount after by being informed of the amount of data after the compression from the drive 2013.

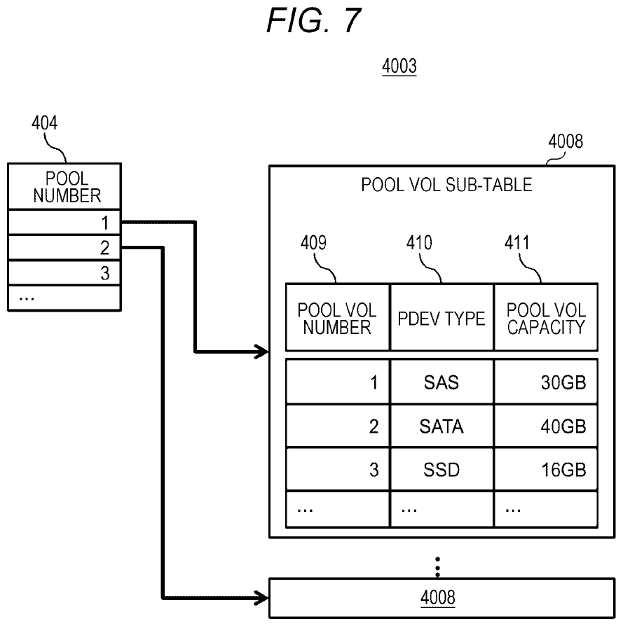

FIG. 7 illustrates a configuration example of the pool VOL table in the management information of the storage apparatus according to the embodiment.

The pool VOL table 4003 is a table that manages the correspondence of the pool VOL belonging to the pool number 404, and includes the pool number 404 and a pool VOL sub-table 4008 for each of the pool numbers 404. The pool VOL sub-table 4008 has an entry for each pool VOL. Information stored in each entry is a pool VOL number 409, a PDEV type 410, and a pool VOL capacity 411.

The pool VOL number 409 indicates an identification number of the VOL constituting the pool. The PDEV type 410 indicates a type of the PDEV which serves as a base of the pool VOL. The pool VOL capacity 411 indicates a capacity of the pool VOL.

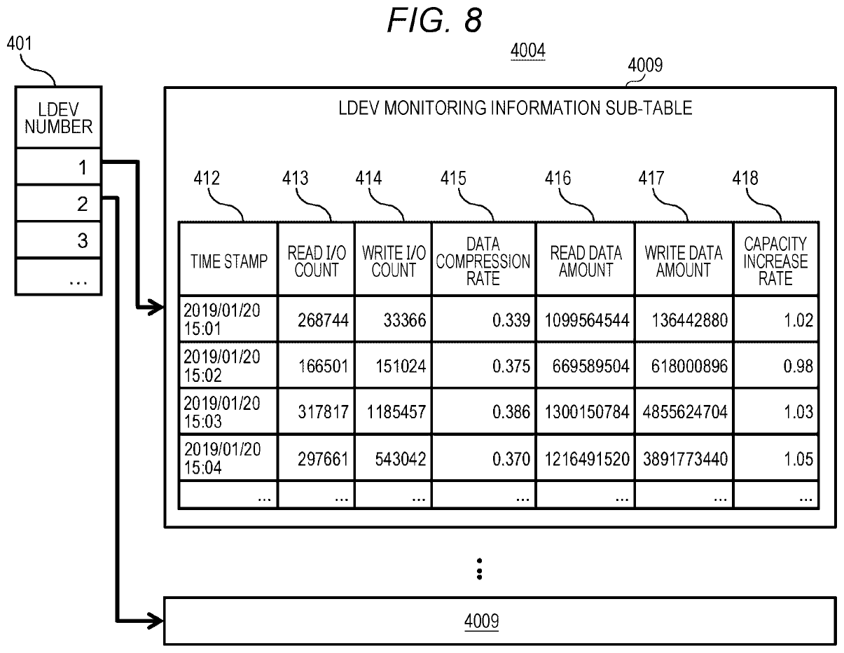

FIG. 8 illustrates a configuration example of the LDEV monitoring information table in the management information of the storage apparatus according to the embodiment.

The LDEV monitoring information table 4004 is a table that manages monitoring information for each LDEV, and includes the LDEV number 401 and an LDEV monitoring information sub-table 4009 for each of the LDEV numbers 401.

The LDEV monitoring information sub-table 4009 has an entry for each time stamp 412, and stores monitored statistical information of the corresponding LDEV in each entry. Information stored in each entry is the time stamp 412, a read I/O count 413, a write I/O count 414, a data compression rate 415, a read data amount 416, a write data amount 417, and a capacity increase rate 418.

The time stamp 412 indicates the time (time stamp) when the monitoring information of the LDEV has been acquired. The read I/O count 413 indicates a read I/O count with respect to the LDEV occurring between the current time and the immediately preceding time stamp 412 (within a certain monitoring period). The write I/O count 414 indicates a write I/O count with respect to the LDEV occurring between the current time and the immediately preceding time stamp 412. The data compression rate 415 indicates a compression rate of write data between the current time and the immediately preceding time stamp 412. The read data amount 416 indicates the amount of data read from the LDEV generated between the current time and the immediately preceding time stamp 412. The write data amount 417 indicates the amount of data written to the LDEV generated between the current time and the immediately preceding time stamp 412. The capacity increase rate 418 indicates a capacity change rate of the LDEV changed between the current time and the immediately preceding time stamp 412.

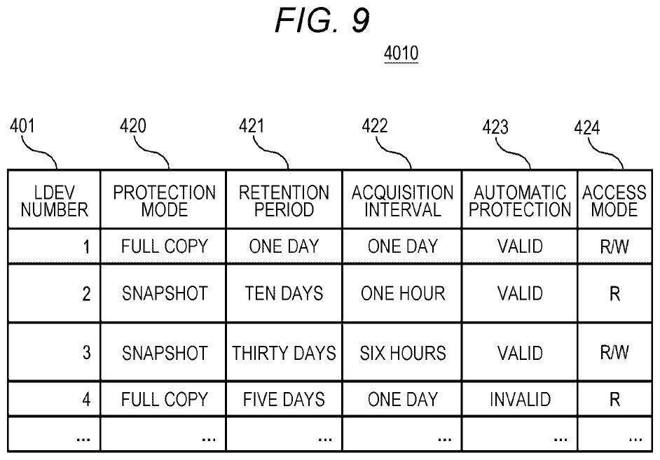

FIG. 9 illustrates a configuration example of the LDEV data protection policy management table in the management information of the storage apparatus according to the embodiment.

The LDEV data protection policy management table 4010 is a table storing information configured to set a data protection policy for each LDEV, and manages information such as an acquisition interval and a retention period of a volume backup and a snapshot of the LDEV.

The LDEV data protection policy management table 4010 has an entry for each LDEV, and information stored in each entry is the LDEV number 401, a protection mode 420, a retention period 421, an acquisition interval 422, automatic protection 423, and an access mode 424.

The LDEV number 401 indicates a number of the LDEV corresponding to the entry. The protection mode 420 indicates a protection mode of the LDEV corresponding to the entry, and includes, for example, “full copy” in which data is protected by copying data of the PVOL 5002 to another SVOL 5001, “snapshot” in which data is protected by acquiring a snapshot of data of the PVOL 5002, and the like.

The retention period 421 indicates a period during which data backups are held in the data protection mode specified by the protection mode 420. The acquisition interval 422 indicates an interval at which the data is acquired in the data protection mode specified by the protection mode 420.

The automatic protection 423 indicates a flag that determines whether to perform data protection even when the abnormality determination program 3005 determines that an abnormality has occurred at a point in time other than the interval specified by the acquisition interval 422, in the data protection mode specified by the protection mode 420.

The access mode 424 indicates a permission mode in which the host 1001 can access the acquired backup or snapshot of the LDEV. For example, “R/W” indicates that the host 1001 is permitted for read and write accesses to the acquired SVOL 5001, and “R” indicates that the host 1001 is permitted for only the read access to the acquired SVOL 5001.

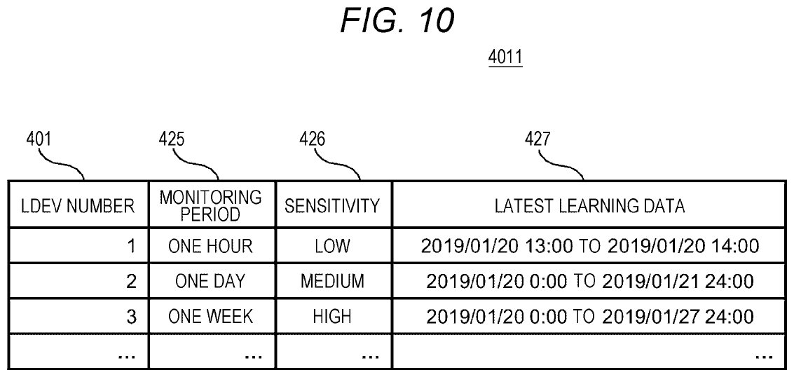

FIG. 10 illustrates a configuration example of the LDEV automatic data protection policy management table in the management information of the storage apparatus according to the embodiment.

The LDEV automatic data protection policy management table 4011 is a table storing information configured to set an automatic data protection policy corresponding to the LDEV for which the automatic protection 423 has been validly set in the LDEV data protection policy management table 4010, and set a learning period of the LDEV access information used in the abnormality determination program 3005, sensitivity of abnormality detection, and the like.

The LDEV automatic data protection policy management table 4011 has an entry for each LDEV, and information stored in each entry is the LDEV number 401, a monitoring period 425, sensitivity 426, and latest learning data 427.

The LDEV number 401 indicates a number of the LDEV corresponding to the entry. The monitoring period 425 indicates a period during which the abnormality determination program 3005 monitors or learns the corresponding LDEV, and the abnormality determination program 3005 learns the access information of the LDEV under the typical operation during this period. The sensitivity 426 sets sensitivity at which the abnormality determination program 3005 detects an access abnormality from access information. The latest learning data 427 indicates a period of the time stamp 412 in the latest LDEV monitoring information table 4004 learned by the abnormality determination program 3005. The sensitivity 426 indicates a threshold used by the abnormality determination program 3005 to determine an abnormality, and can be set, for example, as the sensitivity “high”, the sensitivity “medium”, and the sensitivity “low” when it is determined to be abnormal with a differential of a current input value relative to an input value at the time of learning being a differential of 10% or more, 20%, and 30%, respectively. This input value is, for example, various types of monitoring data in the LDEV monitoring information sub-table 4009. For example, the sensitivity “high”, the sensitivity “medium”, and the sensitivity “low” can be set when the input value is higher than the threshold of the write I/O count 414 by 10%, 20%, and 30%, respectively. The threshold can be set similarly for the read I/O count 413, the data compression rate 415, the read data amount 416, the write data amount, and the capacity increase rate 418 as well as the write I/O count 414.

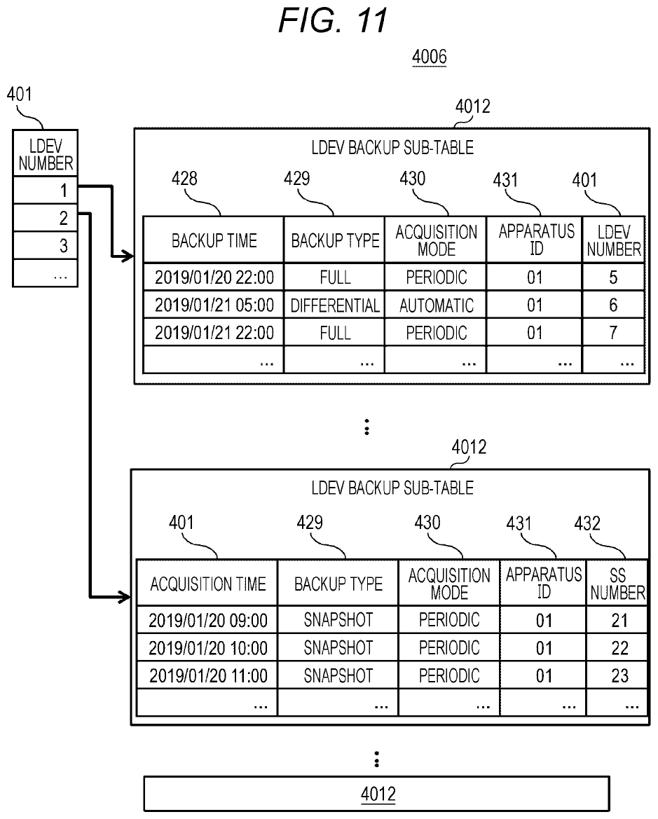

FIG. 11 illustrates a configuration example of the LDEV backup management table in the management information of the storage apparatus according to the embodiment.

The LDEV backup management table 4006 is a table storing information configured to manage backup data of a target LDEV when the volume backup program 3003 protects data of the LDEV.

The LDEV backup management table 4006 includes the LDEV number 401 and an LDEV backup sub-table 4012 managing backup data for each of the LDEV numbers 401.

The LDEV backup sub-table 4012 has an entry for each backup time 428, and information stored in each entry is the backup time 428, a backup type 429, an acquisition mode 430, an apparatus ID 431, the LDEV number 401, or an SS number 432.

The backup time 428 indicates the time when backup data has been created. The backup type 429 indicates a backup data creation mode, and is set as, for example, “full” in the case of acquiring a full backup of the PVOL 5002 in the SVOL 5001, “differential” in the case of acquiring a backup of an update differential of the PVOL 5002 in the SVOL 5001, and “snapshot” in the case of acquiring a snapshot of the PVOL 5002.

The acquisition mode 430 indicates a mode in which backup data has been created, and is set as, for example, “periodic” in the case of backup data created by the volume backup program 3003 based on the acquisition interval 422 of the LDEV data protection policy management table 4010, and “automatic” in the case of backup data crated by the volume backup program 3003 according to an instruction from the abnormality determination program 3005. The apparatus ID 431 is an ID of the apparatus as a creation destination of a backup, and is an identification ID, for example, indicating any apparatus in which the backup data has been crated in the case of constructing the remote replication between the storage apparatus 2000A installed at a local site and the storage apparatus 2000B installed at a remote site. The LDEV number 401 is the LDEV number 401 of the SVOL 5001 having created the backup data. The SS number 432 is an identification number of the snapshot 5003 created as the backup data.

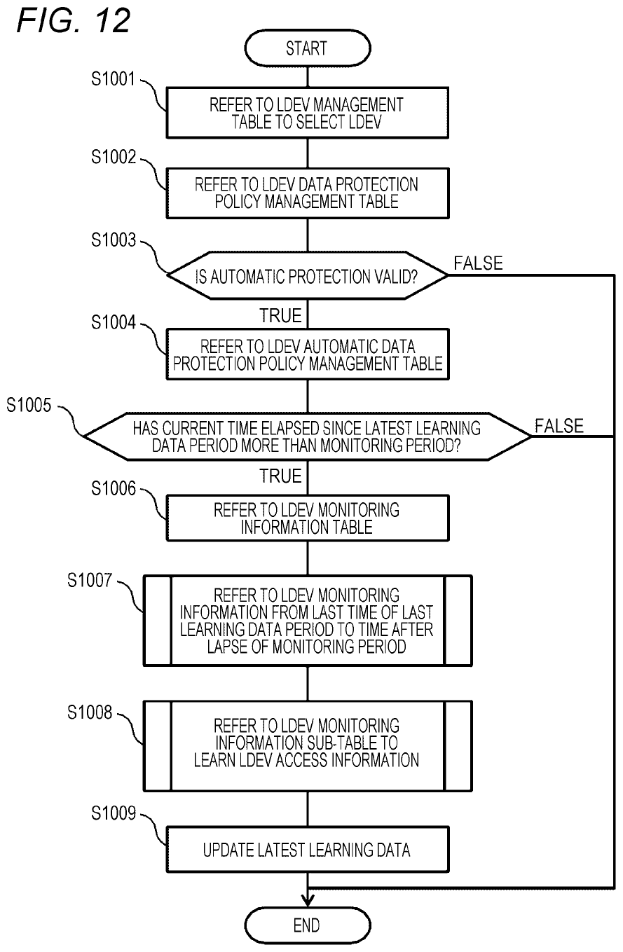

FIG. 12 illustrates an example of learning processing of LDEV access information in the storage apparatus abnormality determination program according to the embodiment.

In Step S1001, the abnormality determination program selects a target LDEV.

In Step S1002, the abnormality determination program refers to the LDEV data protection policy management table 4010 for the target LDEV. In Step S1003, the determination program determines whether the automatic protection 423 has been made valid for the target LDEV, and ends the processing by excluding the LDEV from automatic protection targets when the automatic protection 423 is not valid.

In Step S1004, the abnormality determination program refers to the LDEV automatic data protection policy management table 4011 for the target LDEV, and refers to the latest learning data 427.

In Step S1005, the abnormality determination program determines whether the current time has lapsed since the period of latest learning data 427 more than the monitoring period 425 for the target LDEV, and determines that new learning is not required and ends the processing if not.

In Step S1006, the abnormality determination program refers to the LDEV monitoring information table 4004 for the target LDEV. In Step S1007, the abnormality determination program sets entry information of the time stamp 412 from the last time of the latest learning data 427 of the LDEV monitoring information table 4004 to the time after a lapse of the monitoring period 425 as learning data.

In Step S1008, the abnormality determination program performs learning for the read I/O count 413, the write I/O count 414, the data compression rate 415, the read data amount 416, the write data amount 417, and the capacity increase rate 418 in the LDEV monitoring information sub-table 4009 referred to in Step S1007 for the target LDEV. In Step S1009, the abnormality determination program updates the latest learning data 427 in the LDEV automatic data protection policy management table 4011 for the target LDEV.

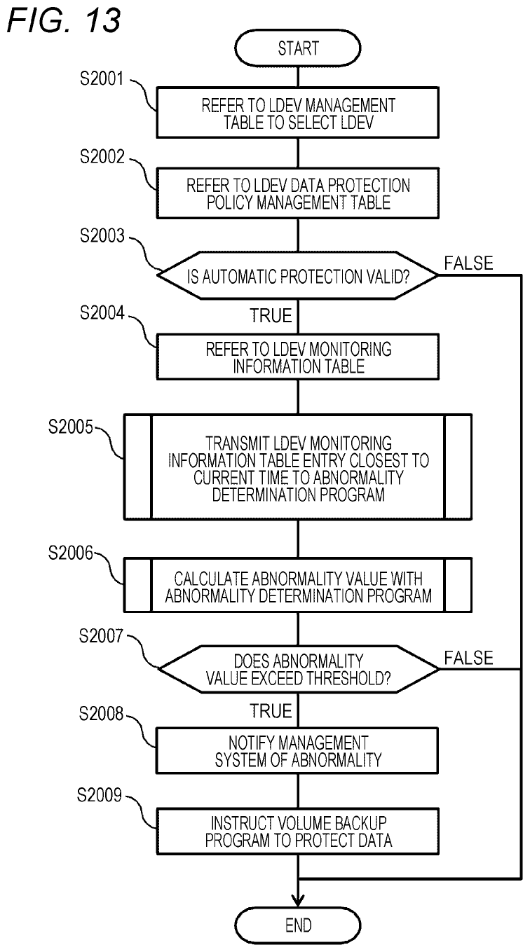

FIG. 13 illustrates an example of an LDEV access abnormality detection processing flow in the LDEV monitoring program of the storage apparatus according to the embodiment.

FIG. 13 illustrates the processing flow in which the LDEV monitoring program 3004 monitors the access of the LDEV of the storage apparatus 2000, and the abnormality determination program 3005 detects the LDEV access abnormality.

In Step S2001, the LDEV monitoring program 3004 selects a target LDEV.

In Step S2002, the LDEV monitoring program 3004 refers to the LDEV data protection policy management table 4010 for the target LDEV.

In Step S2003, the LDEV monitoring program 3004 determines whether the automatic protection 423 has been made valid for the target LDEV, and ends the processing by excluding the LDEV from automatic protection targets when the automatic protection 423 is not valid.

In Step S2004, the LDEV monitoring program 3004 refers to the LDEV monitoring information table 4004 for the target LDEV.

In Step S2005, the LDEV monitoring program 3004 transmits the LDEV monitoring information acquired in Step S2004 to the abnormality determination program 3005. In Step S2006, the abnormality determination program 3005 compares the LDEV monitoring information received in Step S2004 with the learned LDEV monitoring information and calculates an abnormal value. A method of calculating the abnormal value may be a statistical technique, may be a technique based on a machine learning algorithm, or may be a technique using pattern recognition such as deep learning. The determination may be made by comparison with various types of monitoring data in the DEV monitoring information sub-table 4009, for example, the threshold of the number of write I/O count.

That is, the access behavior in the volume deviating from the stored normal state is detected for the PVOL.

In Step S2007, it is determined whether the abnormal value calculated in Step 52006 exceeds a preset threshold. If the abnormal value does not exceed the threshold, the access of the LDEV is regarded to be normal, and the processing is ended. Note that this threshold may be based on the sensitivity 426 in the LDEV automatic data protection policy management table 4011 or may be based on a calculated value based on the statistical scheme used by the abnormality determination program 3005 during learning.

In Step S2008, the storage administrator is notified that an access abnormality has occurred in the target LDEV.

In Step S2009, the volume backup program 3003 is instructed to perform data protection for the target LDEV. As a result, at a point in time of detection, the controller can create the backup data or the snapshot image of the PVOL in the SVOL, and set a restore point to perform management.

As described above, the backup data and the snapshot image can be created autonomously based on the monitoring information in addition to the acquisition of the backup or the snapshot image based on time information set in advance for the primary volume according to the present embodiment

In addition, even if the cyber attack with ransomware that aims at data destruction causes data destruction in the primary volume, the storage administrator can find the cyber attack at an early stage based on the notification from the storage apparatus, and can minimize damage caused by the cyber attack.

In addition, the time and labor required for data recovery work can be greatly reduced by utilizing the autonomously created data backup.

Although one embodiment has been described above, this is an example for describing the invention, and there is no intention to limit the scope of the invention only to the embodiment. The invention can be implemented in various other forms.

What is claimed is:

1. A storage apparatus comprising:
a controller;
a first volume provided to a host; and
a second volume for storage of backup data or a snapshot image of the first volume,
wherein the controller
periodically acquires the backup data or the snapshot image of the first volume at predetermined intervals,
acquires monitoring information including access information of the host and a volume used capacity in the first volume and sets a normal state of the first volume in typical use using the acquired monitoring information,
detects an access behavior in a volume deviating from the set normal state, and
creates the backup data or the snapshot of the first volume in the second volume at a point in time of detection and sets a restore point to perform management.

2. The storage apparatus according to claim 1, wherein the controller notifies a management system connected to the storage apparatus of the set restore point.

3. The storage apparatus according to claim 1, wherein the detection of the access behavior in the volume deviating from the set normal state is performed based on learning data of the normal state for the first volume.

4. The storage apparatus according to claim 1, wherein the detection of the access behavior in the volume deviating from the set normal state is performed based on a write I/O count, a read I/O count, a read data amount, a write data amount, a compression rate of read data, and a compression rate of write data, with respect to the first volume or a threshold of any one of a data compression rate and a capacity increase rate of the first volume.

5. The storage apparatus according to claim 1, wherein the controller includes:
a monitoring unit that acquires monitoring information including the access information of the host and the volume used capacity in the first volume;
an abnormality determination unit that sets the normal state in typical use in the first volume using the acquired information, and detects the access behavior in the volume deviating from the set normal state; and
a volume backup unit that autonomously creates the backup data or the snapshot image of the first volume in the second volume at a point in time of detection.

6. The storage apparatus according to claim 1, wherein the first volume and the second volume are provided in separate storage apparatuses connected via a network.

7. A storage apparatus comprising:
a controller;
a first volume provided to a host; and
a second volume for storage of backup data or a snapshot image of the first volume,
wherein the controller
periodically acquires the backup data or the snapshot image of the first volume at intervals defined by a storage administrator,
acquires monitoring information of the first volume according to a protection policy of the first volume and stores a normal state of the first volume in typical use using the acquired information,
detects an access behavior in a volume deviating from the stored normal state, and
creates the backup data or the snapshot of the first volume in the second volume at a point in time of detection and sets a restore point to perform management.

8. A backup method of a storage apparatus including a first volume provided to a host, and a second volume for storage of backup data or a snapshot image of the first volume,
wherein a controller of the storage apparatus
periodically acquires the backup data or the snapshot image of the first volume at predetermined intervals,
acquires monitoring information including access information of the host and a volume used capacity in the first volume and sets a normal state of the first volume in typical use using the acquired monitoring information,
detects an access behavior in a volume deviating from the set normal state, and
creates the backup data or the snapshot of the first volume in the second volume at a point in time of detection and sets a restore point to perform management.
